(19) United States
(12) Patent Application Publication
(10) Pub. No.: US 2017/0212027 A1
(43) Pub. Date: Jul. 27, 2017

(54) SYSTEM AND PROCESS FOR ANALYZING THE INTERACTION BETWEEN A DROP OF FLUID AND ANOTHER DROP OR A SOLID SURFACE

(71) Applicant: TECLIS, TASSIN LA DEMI-LUNE (FR)

(72) Inventors: Alain CAGNA, FEURS (FR); Gérard ESPOSITO, SAINT CYR AU MONT D'OR (FR)

(73) Assignee: TECLIS, TASSIN LA DEMI-LUNE (FR)

(21) Appl. No.: 15/397,133

(22) Filed: Jan. 3, 2017

(30) Foreign Application Priority Data
Jan. 4, 2016 (FR) 16 50002

(51) Int. Cl. G01N 13/02; G01N 1/14

(52) U.S. Cl. CPC G01N 13/02; G01N 1/14; G01N 2013/0208; G01N 2013/0283; G01N 2001/002

(57) ABSTRACT

The invention relates to a system and a process for analyzing the interaction between a drop of fluid which is immiscible in an ambient medium and a surface, this surface being another drop of fluid or else alternatively a solid surface. The system also comprises processing means suitable for determining, according to data collected by an image acquisition and processing device, a value of interfacial tension of the drop after a contact between the drop and the surface, and a value of pressure difference between the internal pressure of the drop and the pressure in the ambient medium without having to know the position of the apex of the drop. The invention also relates to a device for forming drops and bringing drops into contact and to a device for forming a drop of fluid and bringing a drop of fluid into contact with a solid surface for the purpose of analyzing them by means of the appropriate system.

### TECHNICAL FIELD

The present invention relates to the analysis of fluids based on surface effects.

More particularly, a subject of the present invention is a device for forming and bringing into contact drops of fluids which are immiscible in an ambient medium or else alternatively a device for forming a drop and bringing a drop into contact with a solid surface, and a system and process for analyzing the interaction between a drop of fluid immiscible in an ambient medium and another drop of fluid or else alternatively between a drop of fluid and a solid surface.

### PRIOR ART

The behaviour at the interface of a fluid placed in an ambient medium in which the fluid is immiscible is intimately linked to the tension that is exerted at the interface between this fluid and the ambient medium.

An ambient medium is a medium that is also fluid, in which the fluid under consideration is immersed.

The term “interfacial tension” is generally used when the fluid and the ambient medium are dense, for example the fluid and the ambient medium are both liquids.

The fluid then forms a drop in the ambient medium.

The term “surface tension” is generally used when the fluid and the ambient medium exhibit a considerable difference in density, for example when one of the fluids is a gas and the other of the fluids is a liquid.

The fluid then forms a drop in the ambient medium when the fluid is a liquid and the ambient medium is a gas, and the fluid forms a bubble in the ambient medium when the fluid is a gas and the ambient medium is a liquid.

In the remainder of the description, the term “drop” is used to denote both a drop and a bubble, and the term “interfacial tension” is used to denote both the interfacial tension and the surface tension.

The interfacial tension represents the energy required to create an interface. Consequently, at thermodynamic equilibrium, the interfacial tension reflects the energy used by the inter-molecular cohesion forces between the fluid and the ambient medium in order to keep this interface stable.

This energy results from the product of the interfacial tension multiplied by the total surface area of the interface.

The interfacial tension has the dimension of a force per unit of length, and is expressed for example in Newtons/m or in milliNewtons/m.

Some chemical agents present on the interface may modify the structure of the interface and consequently the value of the interfacial tension. These agents are then referred to as “surfactants”.

The measurement of interfacial tensions can thus be used to evaluate the surfactant activity of certain chemical agents, or indirectly to measure the surface concentration of these chemical agents.

These measurements have many applications, in particular in the oil, pharmaceutical, chemical, food, cosmetics, etc., industries.

By way of example, these measurements are of use for developing effective detergents or emulsifiers; they are of use for developing products for dispersing crude oil in the event of an oil slick, or else for studying enzymatic physiological reactions.

It is known practice to calculate the value of the interfacial tension between a fluid and an ambient medium by the technique known as the hanging drop technique or the sitting drop technique.

The term “hanging drop” is generally used when a drop of fluid is suspended at the end of a capillary tube pointed in the direction of the floor.

However, the term “rising drop” may be more appropriate when the drop undergoes Archimedes' buoyancy in a liquid ambient medium and the end of the capillary tube which holds the drop is directed towards the surface of the liquid.

The term “sitting drop” is, for its part, used when a drop of fluid is placed on a solid surface.

Moreover, only the hanging drop technique is described, the sitting drop technique applying by analogy.

This technique is based on the analysis of the shape of the contour of the profile of a revolution drop placed in a transparent ambient medium.

On the basis of the analysis of an image of a hanging drop formed at the end of a capillary tube and after numerical integration of the position of the points forming the contour of the profile, it is possible to determine the interfacial tension being exerted at the interface of the drop and of the ambient medium.

The drop takes a shape which results from the equilibrium between the forces of gravity and the interfacial tension, and from Archimedes' buoyancy when the ambient medium is liquid.

The effects of the interfacial tension have a tendency to confer a spherical shape on the drop so as to minimize its surface area and thus its energy, while the effects of gravitation have a tendency to elongate it so as to give it a pear shape in the case of a hanging drop.

By analyzing the shape and the dimensions of the drop, it is possible to determine in an absolute manner the value of the interfacial tension.

Indeed, a relationship exists between the value of the interfacial tension and the geometric parameters characterizing the shape of the drop.

This relationship obeys LaPlace's law linking the local curvature of the interface separating two media to the difference in pressure between these two media.

LaPlace's law is defined by an equation termed the “Young-LaPlace equation”:

$$Δ P = γ ( \frac{1}{R} + \frac{1}{{R}^{′}} ) \qquad ( 1 )$$

In the absence of external forces other than gravity, the pressure varies linearly as a function of the height:

ΔP=ΔP₀−(Δρ)gz (2)

Where:
ΔP is the pressure difference between the two fluids at the level of the plane of analysis,
ΔP₀ is the pressure difference between the two fluids at the level of the apex,
γ is the interfacial tension,
R and R′ are the principal radii of curvature of the surface at the point where the pressure difference is measured.

The LaPlace equation does not accept an analytical solution for obtaining the value of the interfacial tension. It may therefore be solved only numerically.

The numerical integration of the LaPlace equation is carried out using initial conditions at the apex of the drop, the apex being the only point of the contour of the drop where the radii of curvature are all equal.

For reasons of symmetry of revolution, it is easy to be in the context of a meridian plane defined by the image of the drop and the meridian curve defining the contour of the drop is referred to as the “profile” of the drop.

Use is made, in this meridian plane, of a reference point of origin, the apex of the drop, which will thus be of a height z₀=0.

b denotes the arithmetical mean of the principal curves at the point of height z₀=0, that is to say:

$$2 b = ( \frac{1}{{R}_{0}} + \frac{1}{{R}_{0}^{′}} )$$

Given the equality of the radii of curvature, b becomes the curvature at the apex.

With s denoting the curvilinear abscissa on the profile with the origin at the apex and with it being noted that, at the point of height z(s), that

$${R}^{′} ( s ) = \frac{x ( s )}{sin θ ( s )}$$

where R′(s) is the radius of curvature at the point M(s) in the perpendicular plane and that

$$R ( s ) = \frac{ds}{d θ}$$

where R(s) is the radius of curvature at the point M(s) in the meridian plane, it is deduced from equations (1) and (2) that, at any point of height z(s):

$$2 b γ = γ ( \frac{d θ}{ds} + \frac{sin θ}{x} ) + Δρ gz$$

By setting down

$$c = \frac{g Δ p}{γ}$$

where c is the capillary constant, the first version of the non-linear LaPlace equation is obtained:

$$\frac{1}{x ( s )} \frac{d}{dx} ( x ( s ) sin ( θ ( s ) ) ) = 2 b - cz ( s ) \qquad ( 3 )$$

This equation depends on four parameters:

s: is the curvilinear abscissa (in mm) of the point M of coordinates [x(s), z(s)]

θ(s): is the polar angle of the oriented tangent at M(s) with the axis Oₓ,

b: is the mean curvature at the apex in mm⁻¹

c: is the capillary constant

$$c = \frac{g Δ ρ}{γ}$$

in mm⁻² where γ is the interfacial tension in mN/m, g is the terrestrial acceleration in m/s² and Δρ is the difference in volume between the two fluids in kg/l or g/cm³.

The normal representation of the contour of the profile by means of the curvilinear abscissa s having as origin the apex of the drop gives the following differential system which represents the mathematical form of the non-linear LaPlace equation (3):

$$[ E ] \text{:} \{ \begin{matrix}\frac{dx}{ds} = cos θ \\ \frac{dz}{ds} = sin θ \\ \frac{d θ}{ds} = 2 b - \frac{sin θ}{x} - cz\end{matrix} \qquad ( 4 )$$

With, as initial conditions at the apex:

$$[ {EC}_{0} ] \text{:} \{ \begin{matrix}x ( 0 ) = 0 \\ z ( 0 ) = 0 \\ θ ( 0 ) = 0\end{matrix}$$

The solving of this equation is based on the estimation solely of the two physical parameters b (curvature at the apex) and c (capillary constant).

The hanging drop method is commonly used, accurate and reproducible.

Nevertheless, a critical and essential condition for the accuracy and the relevance of the conditions consists in knowing very precisely the coordinates of the apex of the drop.

However, in many experimental situations, it is difficult or even impossible to obtain these coordinates. In such situations, the method described above becomes inapplicable.

One of these situations could consist in bringing into contact a drop of a first fluid suspended from a first capillary tube and a drop of a second fluid suspended from a second capillary tube, both placed in an ambient medium.

Another of these situations could consist in bringing a drop of a fluid suspended from a capillary tube into contact with a solid surface.

In such situations, the apex of the drop or of each of the two drops may no longer be distinguished on the image formed after contact of the two drops with one another or after contact of the drop on the solid surface.

Consequently, the measurement of the interfacial tension by the hanging drop method is a known physical technique which has its limits through the need to have extremely precise knowledge of the apex of the drop. Without this knowledge, no measurement is possible.

The analysis of such situations could however prove to be particularly advantageous since it would make it possible to model various interfaces naturally encountered.

For example, two drops of water placed in contact with one another form an interface which, under certain conditions, reproduces a portion of cell membrane of a living cell.

Indeed, living cells are composed essentially of 65% to 90% of water and covered with a phospholipids bilayer.

Thus, when a first drop of water comprising surfactants and covered beforehand with a phospholipids monolayer is brought into contact with a second drop of water comprising surfactants and also covered beforehand with a phospholipid monolayer then, at the level of the contact between the two drops, a phospholipid bilayer forms which is similar to a portion of a cell membrane of a living cell.

Consequently, it would be possible to study the diffusion of a compound or of a molecule through this cell membrane, for example according to the amount of surfactants, for example of proteins, present in either of the two drops of water.

Another of these situations may occur after the coalescence of two drops and the formation of a liquid bridge.

In such a situation, the two drops, and therefore their apex, disappear so as to form a liquid bridge.

The time taken for the coalescence between the two drops may also prove to be advantageous since it depends on the pressure difference between the two drops and on the quality of the interface.

This pressure difference, when it is correlated with the interfacial tension values of the drops before and after coalescence, makes it possible to obtain relevant information on the stability of the interface.

This information is most particularly advantageous for the production of aqueous foams of which the amount of air incorporated and thus the density of bubbles is an important characteristic.

Another of these situations could consist in suspending a drop from a capillary tube, in bringing this drop into contact with a solid surface and then in exerting stresses on the drop in contact with the solid surface.

Here again, the apex of the drop may no longer be distinguished on the image formed after contact of the drop with the solid surface.

The analysis of such a situation could be of use for studying the wetting of the drop on the solid surface or else determining the pressure exerted on the drop starting from which the drop no longer adopts a LaPlacian behaviour, in other words the pressure exerted on the drop starting from which the interfacial pressure is no longer considered to be the same over the entire surface of the drop.

There is thus a need to improve the existing analysis processes in order to be able to carry out analyses in which the position of the apex can no longer be determined, as is the case during the interaction of a drop with another drop or alternatively during the interaction of a drop with a solid surface in situations or else analyses in which there is no longer an apex, as is the case during the coalescence of two drops and the formation of a liquid bridge.

The objective of the present invention is to resolve all or some of the abovementioned drawbacks.

### SUMMARY OF THE INVENTION

To this effect, the present invention relates to a device for forming and bringing into contact drops of fluids which are immiscible in an ambient medium, comprising:
a first capillary tube comprising an end capable of opening out into the ambient medium and a rectilinear end portion extending vertically from the end of the capillary tube,
a first syringe-driver assembly connected to the first capillary tube and suitable for:
conveying a first fluid through the first capillary tube to its end, and
controlling the volume of a first drop of first fluid formed at the end of the first capillary tube,
a second capillary tube comprising an end capable of opening out into the ambient medium and a rectilinear end portion extending vertically from the end of the capillary tube,
a second syringe-driver assembly connected to the second capillary tube and suitable for:
conveying a second fluid through the second capillary tube to its end, and
controlling the volume of a second drop of a second fluid formed at the end of the second capillary tube in the ambient medium,
means for bringing the two drops into contact, having a relative arrangement of the end of the first capillary tube with respect to the end of the second capillary tube that is suitable for bringing the two drops into contact.

This arrangement makes it possible to form two distinct drops in an ambient medium for the purpose of the subsequent analysis of the interaction between these drops of fluids which are immiscible in an ambient fluid.

The rectilinear end portion which extends vertically from the end of the capillary tube under consideration makes it possible to confer, on the drop suspended from the capillary tube, a symmetry of revolution.

This arrangement also makes it possible to increase or decrease the volume of a liquid bridge formed after coalescence of the two drops and to cause the interface to oscillate in dilation or in compression by controlling the volume of the two drops.

The present invention also relates to a device for forming a drop of fluid which is immiscible in an ambient medium and bringing a drop of fluid which is immiscible in an ambient medium into contact with a solid surface, comprising:
a capillary tube comprising an end capable of opening out into the ambient medium and a rectilinear end portion extending vertically from the end of the capillary tube,
a syringe-driver assembly connected to the first capillary tube and suitable for:
   conveying a fluid through the first capillary tube to its end, and
   controlling the volume of a drop of first fluid formed at the end of the first capillary tube,
means for bringing the drop into contact, having a relative arrangement of the end of the capillary tube with respect to the solid surface that is suitable for bringing the drop and the solid surface into contact.

This arrangement makes it possible to form a drop in an ambient medium for the purpose of the subsequent analysis of the interaction between this drop of fluid which is immiscible in an ambient medium and a solid surface.

The rectilinear end portion which extends vertically from the end of the capillary tube makes it possible to confer, on the drop suspended from the capillary tube, a symmetry of revolution.

According to one aspect of the invention, the means for bringing into contact comprise means for relative movement of the end of the first capillary tube with respect to the end of the second capillary tube, where appropriate the means for bringing into contact comprise means for relative movement of the end of the capillary tube with respect to the solid surface.

The means for relative movement of the end of the first capillary tube with respect to the end of the second capillary tube make it possible to bring the two drops into contact when the ends of the two capillary tubes are distant during the formation of the two drops.

Indeed, if the ends of the two capillary tubes are already sufficiently close, then the increase in volume of the two drops during their formation may be sufficient to bring them into contact.

The term “capillary tube” is intended to mean the usual definition of this term, namely a very thin tube capable of maintaining a drop in suspension due to the phenomenon of capillary action.

According to one aspect of the invention, the rectilinear end portion of the first capillary tube and the rectilinear end portion of the second capillary tube are placed along one and the same axis, and the end of the first capillary tube and the end of the second capillary tube being placed opposite one another in the ambient medium.

This arrangement makes it possible to form two drops opposite one another in order to facilitate bringing them into contact at the level of their respective apex.

The first drop is a hanging drop and the second drop is a rising drop.

According to a second embodiment, the rectilinear end portion of the first capillary tube and the rectilinear end portion of the second capillary tube are respectively placed along two substantially parallel axes, the end of the first capillary tube and the end of the second capillary tube being placed side by side in the ambient medium.

This second embodiment makes it possible to study the behaviour at the interface of two drops placed side by side.

According to one aspect of the invention, the movement means comprise means for translational movement or means for translational and rotational movement of the end of the first capillary tube with respect to the end of the second capillary tube.

This arrangement makes it possible to bring the two drops into contact by means of a simple translational movement, and also makes it possible to stretch the interface by modifying the distance between the two capillary tubes.

Of course, just one of the two capillary tubes may be moved while the other may remain fixed.

This arrangement also makes it possible, after bringing the two drops into contact, to shear the interface, for example by initiating a rotational movement of one of the two capillary tubes, the other remaining fixed.

According to one aspect of the invention, the end of the first capillary tube and, where appropriate, the end of the second capillary tube are placed in a transparent cuvette.

This arrangement makes it possible to form drops or bubbles in a liquid ambient medium.

According to one aspect of the invention, the end of the first capillary tube and, where appropriate, the end of the second capillary tube are placed in a thermostatic chamber, where appropriate the cuvette is placed in the thermostatic chamber.

This arrangement makes it possible to contribute to the thermodynamic equilibrium of the interfaces, which depend, inter alia, on the temperature.

According to one aspect of the invention, the first capillary tube comprises a needle placed coaxially inside the first capillary tube and protruding at the end of the first capillary tube, and/or, where appropriate, the second capillary tube comprises a needle placed coaxially inside the second capillary tube and protruding at the end of the second capillary tube.

This arrangement makes it possible to inject one or more compounds into a drop while at the same time preserving a constant drop volume.

The present invention also relates to a system for analyzing the interaction between drops of fluids which are immiscible in an ambient medium, comprising:
a device for forming drops and bringing drops into contact, as described above,
a device for image acquisition and processing suitable for collecting data relating to the dimensions and to the shape of the contour:
   of an individual profile of the first drop and of an individual profile of the second drop before a contact between the first drop and the second drop, or
   of a profile of contact of the first drop and of the second drop resulting from a contact between the first drop and the second drop, or
   of a profile of a liquid bridge resulting from the coalescence between the first drop and the second drop, and
processing means suitable for determining, according to the data collected by the image acquisition and processing device:
a value of interfacial tension:
   of the first drop and of the second drop before a contact between the first drop and the second drop, where appropriate
   of the first drop and of the second drop after a contact between the first drop and the second drop, where appropriate
   of the liquid bridge resulting from the coalescence between the first drop and the second drop, and/or
a value of pressure difference:
   between the internal pressure of the first drop and the ambient medium, and between the internal pressure of the second drop and the ambient medium, where appropriate
   between the internal pressure of the liquid bridge and the ambient medium.

Such a system makes it possible to analyze the interaction of drops of fluid by means of their interfacial tension value without having to know the position of the apex of these drops of fluid.

Such a system also makes it possible to work back to the value of the interfacial tension of a liquid bridge formed after coalescence of the two drops.

In addition, such a system makes it possible to know, by means of a direct technique, the pressure differences between the two drops and between the two drops and the ambient medium.

The present invention also relates, as an alternative, to a system for analyzing the interaction of a drop of immiscible fluid with a solid surface in an ambient medium, comprising:
a device for forming a drop and bringing a drop into contact with a solid surface, as described above,
a device for image acquisition and processing suitable for collecting images relating to the dimensions and to the shape of the contour:
   of an individual profile of the drop before a contact between the drop and the solid surface,
   of a contact profile of the drop resulting from the contact between the drop and the solid surface,
processing means suitable for determining, according to the data collected by the image acquisition and processing device:
   a value of interfacial tension:
   of the drop before a contact between the drop and the solid surface, where appropriate
   of the drop after a contact between the drop and the solid surface, and/or
   a value of pressure difference between the internal pressure of the drop and the pressure in the ambient medium.

This alternative makes it possible to analyze the interaction of a drop of fluid on a solid surface by means of its interfacial tension value without having to know the position of the apex of the drop of fluid.

In addition, this alternative also makes it possible to know, by means of a direct technique, the pressure difference between the internal pressure of the drop and the pressure in the ambient medium.

According to one aspect of the invention, the system comprises a first pressure sensor suitable for measuring the pressure in the first capillary tube and, where appropriate, a second pressure sensor suitable for measuring the pressure in the second capillary tube.

This arrangement makes it possible to measure the internal pressure values of the drop under consideration when the drop no longer adopts LaPlacian behaviour, that is to say in situations where the interfacial pressure is no longer considered to be the same over the entire surface of the drop.

These sensors may thus be used to determine the pressure difference between two drops starting from which the two drops coalesce.

According to one aspect of the invention, the image acquisition and processing device comprises:
a light source mounted on a first side of an optical bench, and
a camera mounted on a second side of said optical bench,
the device for forming drops being placed in alignment with the optical bench between the light source and the camera.

This arrangement makes it possible to obtain a highly contrasted image which makes it possible to optimize the definition of the contours of a shape on an image.

The present invention also relates to a process for analyzing the interaction between drops of fluids which are immiscible in an ambient medium, comprising the following steps:
providing an analyzing system as defined above for analyzing the interaction between two drops,
forming a first drop of a first fluid at the end of a first capillary tube placed in the ambient medium,
forming a second drop of a second fluid at the end of a second capillary tube placed in the ambient medium,
moving the end of the first capillary tube with respect to the end of the second capillary tube until there is contact between the first drop and the second drop,
determining a minimized quadratic error function using the processing means for obtaining a better value of the four parameters (b, c, R₀, q₀) of a LaPlace curve associated with the objective function L(b, c, R₀, q₀), said minimized quadratic error function characterizing the difference between an experimental profile and a better theoretical profile of a contour of the profile of the drop,
if the values of the four parameters are such that this difference is less than a predetermined applicability threshold, then determining, using the processing means:
a value of interfacial tension of the first drop and of the second drop after a contact between the first drop and the second drop, and/or, where appropriate, a value of interfacial tension of the liquid bridge resulting from the coalescence between the first drop and the second drop, and
the values of the internal pressures in the first drop and the second drop, and/or, where appropriate, the value of the internal pressure in the liquid bridge
if not,
determining a value of pressure difference between the internal pressure of the first drop and the ambient medium, and between the internal pressure of the second drop and the ambient medium, by means of pressure sensors suitable for measuring the pressure in the first capillary tube and in the second capillary tube.

This arrangement makes it possible to determine interfacial tension and internal pressure values on drops for which the position of the apex cannot be determined.

This arrangement also makes it possible to determine the interfacial tension and internal pressure values on liquid bridges formed following the coalescence of the two drops.

This arrangement also makes it possible to determine a minimized quadratic error function which provides the operator with relevant information on the experimental conditions of the analysis and thus on the relevance of the interfacial tension and internal pressure values determined by the processing means.

The present invention also relates, as an alternative, to a process for analyzing the interaction of a drop of immiscible fluid with a solid surface in an ambient medium, comprising the following steps:
providing an analyzing system as described above for the analysis between a drop and a solid surface,
forming a drop of fluid at the end of a first capillary tube placed in the ambient medium,
moving the end of the first capillary tube with respect to the solid surface until there is contact between the drop and the solid surface,
determining a minimized quadratic error function using the processing means for obtaining a better value of four parameters (b, c, R₀, q₀) of a LaPlace curve associated with the objective function L (b, c, R₀, q₀), said minimized quadratic error function characterizing the difference between an experimental profile and a better theoretical profile of a contour of the profile of the drop,
if the values of the four parameters are such that this difference is less than a predetermined applicability threshold, then determining, using the processing means:
a value of interfacial tension of the drop after a contact between the drop and the solid surface, and
a value of pressure difference between the internal pressure of the drop and the pressure in the ambient medium,
if not,
determining a value of pressure difference between the internal pressure of the drop and the pressure in the ambient medium by means of a pressure sensor suitable for measuring the pressure in the first capillary tube.

This arrangement makes it possible to determine interfacial tension and internal pressure values on a drop for which the position of the apex cannot be determined.

This arrangement also makes it possible to determine a minimized quadratic error function which provides the operator with relevant information on the experimental conditions of the analysis and thus on the relevance of the interfacial tension and internal pressure values determined by the processing means.

According to one implementation of the process, the first drop has a first interfacial tension value and the second drop has a second interfacial tension value different from the first value before contact between the first drop and the second drop, said process also comprising a step consisting in repeating at least one step consisting in determining a value of interfacial tension of the first drop and of the second drop after a contact between the first drop and the second drop.

This arrangement makes it possible to analyze the influence of a first drop on the change over time of the interfacial tension of a second drop during the contact between these two drops.

According to one implementation of the process, the process also comprises a step consisting in timing, after contact between the first drop and the second drop, the time taken to obtain coalescence between the first drop and the second drop.

This arrangement makes it possible to establish a classification of fluids as a function of their ability to coalesce or not with other fluids.

According to one implementation of the process, the process comprises steps consisting in:
increasing or decreasing the volume of the liquid bridge,
stretching the interface of the liquid bridge with the ambient medium by modifying the distance between the end of the first capillary tube and the end of the second capillary tube, or
shearing the interface of the liquid bridge by turning the end of the first capillary tube with respect to the end of the second capillary tube.

This arrangement makes it possible to control the variation of the interfacial tension of the liquid bridge as a function of stresses exerted on said liquid bridge.

According to one implementation of the process, the steps consisting in determining a minimized quadratic error function, an interfacial tension value and an internal pressure value of the drop using the processing means comprise the following operations:
defining at least one zone of optical analysis of a contour from an image of a profile of contact of the first drop and of the second drop resulting from a contact between the first drop and the second drop, and/or, where appropriate, from an image of a profile of a liquid bridge resulting from the coalescence between the first drop and the second drop or alternatively from an image of a profile of a drop resulting from a contact between the drop and a solid surface,
extracting from the image the position of experimental points of the contour of the profile of the first drop and/or of the second drop, and/or, where appropriate, of experimental points of the contour of the profile of the liquid bridge or alternatively of experimental points of the drop,
on the basis of the experimental points, carrying out a first estimation of:
   the polar angle q₀ of the oriented tangent at M₀, point located on the reference plane defining a horizontal axis Oₓ,
   R₀, the radius of curvature in a plane orthogonal to the axis of revolution and passing through the axis Oₓ,
   the mean curvature b at the point M₀,
   the capillary constant c at the interface between the fluid under consideration and the ambient medium,
applying an algorithm so as to deduce, from the first estimation of the four parameters (b, c, R₀, q₀) and the acquisition of the experimental points of the contour of the profile, a second optimized estimation of the four parameters (b, c, R₀, q₀) by an optimized approximation of the contour of the profile of the first drop and/or of the second drop, and/or, where appropriate, of the contour of the profile of the liquid bridge or alternatively of the profile of the drop via a LaPlace curve associated with the objective function (b, c, R₀, q₀) which solves the differential equation E:

$$[ E ] \text{:} \{ \begin{matrix}\frac{dx}{ds} = cos θ \\ \frac{dz}{ds} = sin θ \\ \frac{d θ}{ds} = 2 b - \frac{sin θ}{x} - cz\end{matrix} \qquad ( 4 )$$

with, as initial conditions at the point M₀:

$$[ {EC}_{0} ] \text{:} \{ \begin{matrix}x ( 0 ) = {R}_{0} \\ z ( 0 ) = 0 \\ θ ( 0 ) = {θ}_{0}\end{matrix}$$

determining the minimized quadratic error function and, where appropriate, determining the interfacial tension value and the internal pressure value of the first and/or of the second drop or, where appropriate, of the liquid bridge or alternatively of the drop as a function of the optimized approximation obtained in the preceding step.

This arrangement makes it possible to accurately and reproducibly determine an interfacial tension value of a drop or of a liquid bridge from a contour of the profile without apex.

According to one implementation of the process, the minimized quadratic error function is determined by automatic program derivation for using a minimization method together with a method for numerical solution of the differential equation [E].

This arrangement makes it possible to solve the differential equation [E] for different values of quartets of the four parameters (b, c, R₀, q₀) for determining which of these quartets minimizes the quadratic error function the most.

The minimization method uses a “Newton-Raphson” method, while the method for solving the differential equation [E] uses a “Bragg-Stoer-Bulirsch” method.

According to one implementation of the process, the at least one zone of optical analysis of a contour of the profile is selected between a first horizontal axis located in proximity to the interface between the two drops and a second horizontal axis located in proximity to the end of the first capillary tube for a measurement on the first drop or in proximity to the end of the second capillary tube for a measurement on the second drop, and/or, where appropriate, the at least one zone of optical analysis of a contour of the profile is selected between a first horizontal axis located in proximity to the end of the second capillary tube and a second horizontal axis located in proximity to the end of the first capillary tube, or alternatively the at least one zone of optical analysis of a contour of the profile is selected between a first horizontal axis located in proximity to the solid surface and a second horizontal axis located in proximity to the end of the first capillary tube.

This arrangement makes it possible to define a zone of analysis with a maximum of points of the contour of the profile, thereby further optimizing the approximation which is made on the points of the contour of the profile.

According to one implementation of the process, the extraction, on the image, of the position of experimental points of the contour of the profile comprises thresholding obtained from a histogram of the levels of grey and sub-pixellization by means of a method termed Spline approximation method.

This sub-pixellization makes it possible to obtain an accuracy of the position of a point on an image above the value of one pixel, ideally at a resolution of 0.1 pixel.

This arrangement makes it possible to easily and very accurately detect the position of the contour of the profile by processing of the signal of the image.

The present invention also relates to an application of the system for analyzing the interaction between drops of fluids which are immiscible in an ambient medium as described above and/or an application of the process for analyzing the interaction between drops of fluids which are immiscible in an ambient medium as described above, for analyzing a cell membrane.

Such an application makes it possible to model a portion of cell membrane of a living cell and thus makes it possible, for example, to study the interaction between a given molecule and the portion of cell membrane thus formed and also its influence or not on the interfacial tension and the internal pressure of the drop into which the molecule is injected.

The present invention also relates to an application of a system for analyzing the interaction of a drop of fluid which is immiscible in an ambient medium with a solid surface as described above and/or of the process for analyzing the interaction of a drop of fluid which is immiscible in an ambient medium with a solid surface as described above, for analyzing a drop of hydrocarbon.

This arrangement makes it possible to model an interface between a drop of hydrocarbon and a solid surface, and thus makes it possible to study, for example, the wetting of the drop on the solid surface as a function of the nature of the given molecules injected into the drop or else to determine the internal pressure starting from which the drop no longer adopts Laplacian behaviour.

### DETAILED DESCRIPTION

Other advantages and characteristics of the invention will emerge more clearly on reading the detailed description of the invention given by way of illustration, and which is non-limiting, with reference to the figures which illustrate all or part of a system for analyzing the interaction between drops of fluids according to the invention.

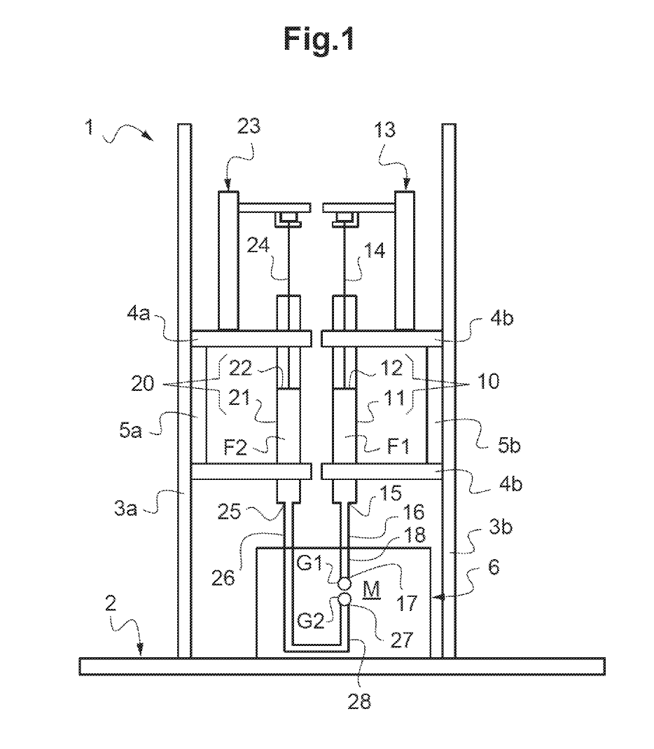

FIG. 1 illustrates a first embodiment of a device for forming drops of fluids which are immiscible in an ambient medium according to the invention.

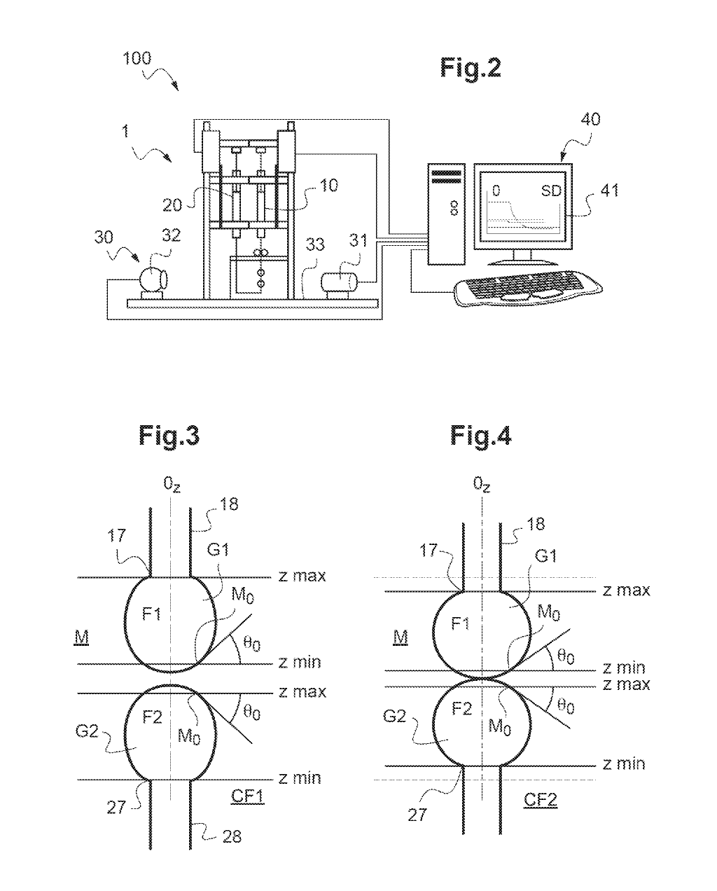

FIG. 2 shows a system for analyzing the interaction between drops of fluids which are immiscible in an ambient medium according to the invention, comprising a device for forming drops according to the first embodiment of FIG. 1.

FIG. 3 shows the image of the shape of the profile of two drops before contact.

FIG. 4 shows the image of the shape of the profile of two drops in contact.

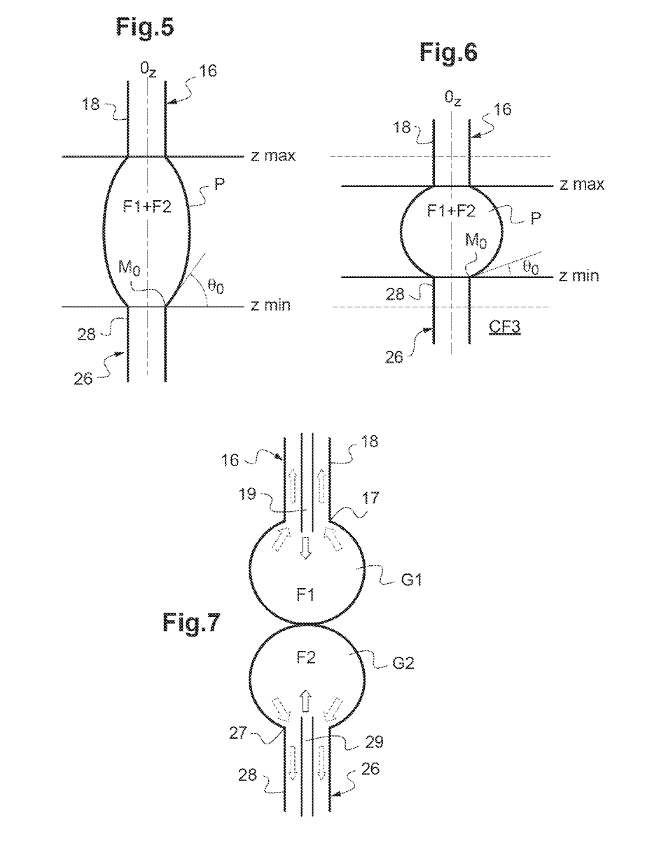

FIG. 5 shows the image of the shape of the profile of the liquid bridge formed after coalescence between the two drops.

FIG. 6 shows the image of the shape of the profile of the liquid bridge after compression.

FIG. 7 illustrates the injection of a compound into a drop while maintaining a constant drop volume.

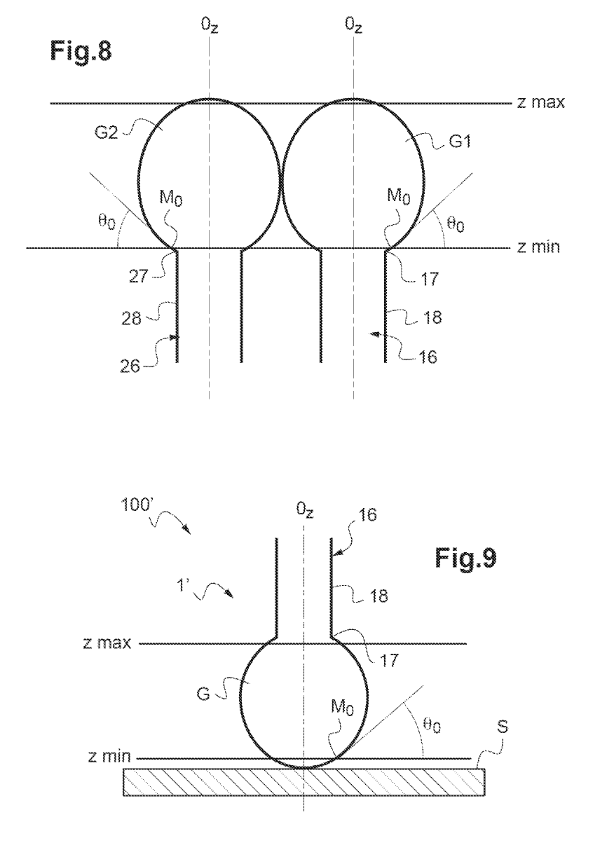

FIG. 8 shows the image of the shape of the profile of two drops in contact, formed by a device for forming drops according to a second embodiment in which the two capillary tubes are placed side by side.

FIG. 9 shows the image of the shape of the profile of a drop in contact with a solid surface according to an alternative to the analyzing system illustrated in FIG. 2.

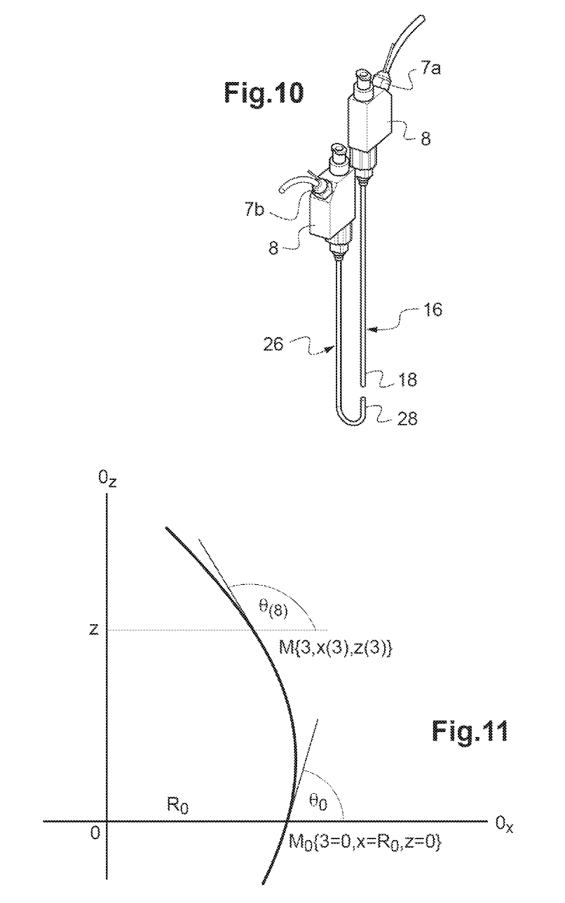

FIG. 10 illustrates the positioning of pressure sensors used to obtain a direct measurement of the internal pressures of the drops formed at the ends of the capillary tubes.

FIG. 11 illustrates the principle of acquisition of a point on the contour of the profile of a drop or of a liquid bridge according to the invention.

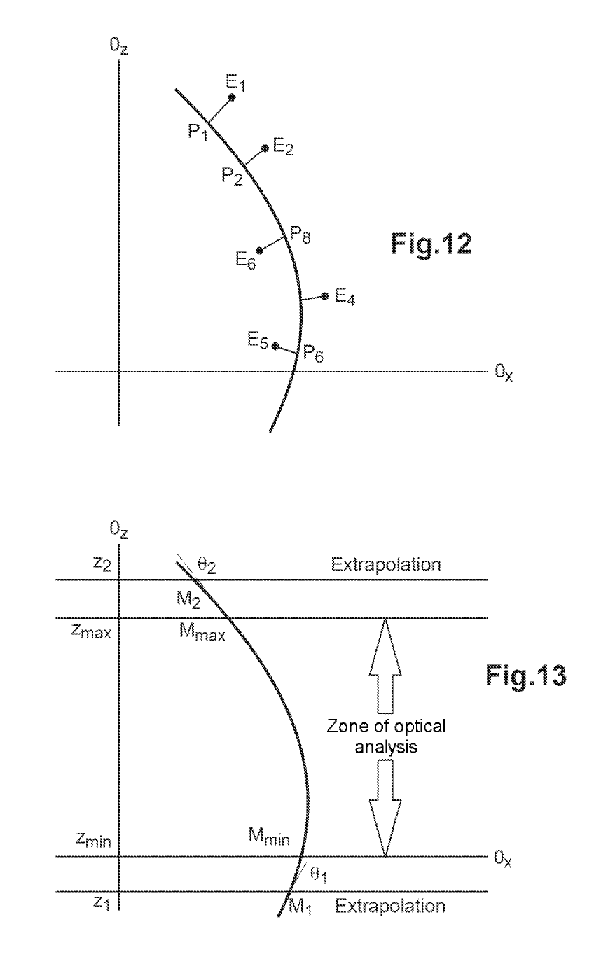

FIG. 12 illustrates the projection of experimental points on a theoretical curve of approximation for the application of an analyzing process according to the invention.

FIG. 13 illustrates a zone of optical analysis on a theoretical curve of approximation of the shape of a contour of the profile for the application of an analyzing process according to the invention.

As illustrated in FIG. 1, a device 1 for forming drops of fluids which are immiscible in an ambient medium M comprises a framework 2 comprising a first upright 3a supporting a first assembly 4a of cross-members, and a second upright 3b supporting a second assembly of cross-members 4b.

The first assembly 4a of cross-members and the second assembly 4b of cross-members are suitable for supporting respectively a first syringe-driver assembly 10 and a second syringe-driver assembly 20.

Each assembly 4a, 4b of cross-members is translationally mobile in the vertical direction relative to the uprights 3a, 3b which support them.

These translational movements are managed with great precision by movement means 5a, 5b.

These movement means 5a, 5b comprise, for example, stepper motors connected to a rack-and-pinion system.

The first syringe-driver assembly 10 comprises a cylinder 11 suitable for containing a first fluid F1 and a plunger 12 adjusted to the diameter of the cylinder 11 and which can move translationally in a leakproof manner inside the cylinder 11.

The movement of the plunger 12 is managed with great precision by movement means 13 connected to the plunger 12 by a shaft 14.

These movement means 13 comprise, for example, a stepper motor connected to a screw-nut system.

The cylinder 11 comprises a passage 15 connected in a leakproof manner to a first capillary tube 16.

The first capillary tube 16 has an end 17 which opens out into the ambient medium M and also a rectilinear end portion 18 extending vertically from this end 17.

Likewise, the second syringe-driver assembly 20 comprises a cylinder 21 suitable for containing a second fluid F2 and a plunger 22 that can move translationally in a leakproof manner inside the cylinder 21.

The movement of the plunger 22 is managed with great precision by movement means 23 connected to the plunger 22 by a shaft 24.

These movement means 23 comprise, for example, a stepper motor connected to a screw-nut system.

The cylinder 21 comprises a passage 25 connected in a leakproof manner to a second capillary tube 26.

The second capillary tube 26 has an end 27 which opens out into the ambient medium M and also a rectilinear end portion 28 extending vertically from this end 27.

Thus, the actuating of the movement means 13, 23 makes it possible to form a first drop G1 and a second drop G2 of fluid respectively at the end 17 of the first capillary tube 16 and at the end 27 of the second capillary tube 26 in the ambient medium M with a precise control of the volume of the drops G1, G2.

The first drop G1 and the second drop G2 exhibit a symmetry of revolution about an axis of symmetry which coincides with the axis of symmetry of the rectilinear end portion 18, 28 of the capillary tube 16, 26 under consideration.

Finally, according to a first embodiment, the end 17 of the first capillary tube 16 and the end 27 of the second capillary tube 26 are placed opposite one another in the ambient medium M.

In a second embodiment illustrated in FIG. 8, the rectilinear end portion 18 of the first capillary tube 16 and the rectilinear end portion 28 of the second capillary tube 26 are respectively placed along two substantially parallel axes, the end 17 of the first capillary tube 16 and the end 27 of the second capillary tube 26 being placed side by side in the ambient medium M.

The actuating of one and/or both movement means 5a, 5b makes it possible, for its part, to control with great precision the relative translational movement of the end 17 of the first capillary tube 16 with respect to the end 27 of the second capillary tube 26.

Means for rotational movement (not illustrated) of the end of a capillary tube with respect to the other could also be envisaged for analyzing the behaviour of the interface between two drops when the interface is subjected to a shear stress.

The ambient medium M in which these drops G1, G2 are formed is a fluid, that is to say that the ambient medium M may be either a gas, for example air, or a liquid, for example water.

This ambient medium M is transparent, that is to say that the ambient medium M allows visualization of the contour of the profile of the drops G1, G2 formed at the ends 17, 27 of the capillary tubes 16, 26.

In the case where the ambient medium M is a liquid, then the device 1 comprises a transparent cuvette 6 capable of containing the liquid.

This cuvette 6 may also be used when the ambient medium M is a gas other than air, the cuvette 6 is then leakproof so as to retain this gas.

Of course, the cuvette 6 may also be used when the ambient medium M is air. In this case, it is not necessary for the cuvette 6 to be leakproof.

The ends 17, 27 of the capillary tubes 16, 26, and where appropriate the cuvette 6, are placed in a thermostatic chamber (not illustrated) so as to guarantee a constant temperature of the ambient medium M and thus a thermodynamic equilibrium.

It may also be envisaged to place the cylinders 11, 21 in a thermostatic chamber so as to guarantee a constant temperature of the fluids F1, F2 in the cylinders 11, 21.

The fluids F1, F2 are not miscible in the ambient medium M and may or may not be of the same nature.

Typically, two fluids F1, F2 are said to be of the same nature when the first fluid F1 is the same fluid as the second fluid F2.

In one variant partially illustrated in FIG. 7, the first capillary tube 16 comprises a hollow needle 19 placed coaxially inside the first capillary tube 16 and protruding at the end 17 of the first capillary tube 16.

Likewise, the second capillary tube 26 comprises a hollow needle 29 placed coaxially inside the second capillary tube 26 and protruding at the end 27 of the second capillary tube 26.

These hollow needles 19, 29 may each be connected to a syringe-driver assembly such as the syringe-driver assemblies 10, 20 described above.

If the syringe-driver assembly connected to a hollow needle 19, 29 is coupled to the syringe-driver assembly 10, 20 connected to the capillary tube 16, 26 in which the hollow needle 19, 29 under consideration is placed, it becomes possible to inject, via the hollow needle 19, 29, a fluid comprising a different composition, a specific marker or a surfactant inside a drop G1, G2 and to simultaneously suction a part of the fluid forming the drop G1, G2 so as to preserve a constant volume of the drop G1, G2.

When the ambient medium M is liquid, it is also possible to directly inject into the ambient medium M different compositions or surfactants so as to provide for analyzing the behaviour of the drops at their interface with the ambient medium M.

Surfactants will thus have a tendency to increase the surface of the drops G1, G2 and thus to modify their profile contour while at the same time keeping their volume constant.

As illustrated in FIG. 2, a system 100 for analyzing the interaction between drops G1, G2 of fluids F1, F2 which are immiscible in an ambient medium M comprises a device 1 for forming drops G1, G2 as defined above.

In addition, the system 100 also comprises a device 30 for image acquisition and processing and processing means 40.

The image acquisition and processing device 30 comprises a light source 31 and a camera 32 mounted on one and the same optical bench 33.

The light source 31 produces a scattered light capable of illuminating in a contrasted manner the ends 17, 27 of the capillary tubes 16, 26.

To this effect, this light source 31 is placed on a first side of the optical bench 33, whereas the camera is placed on a second side of the optical bench 33, the device 1 for forming drops being placed in alignment with the optical bench 33 between the light source 31 and the camera 32.

The camera 32 thus allows the acquisition of data on the profile of the drops G1, G2 in a plane that is substantially transverse to the axis of alignment of the optical bench 33.

The camera 32 has a resolution of at least 1920×1200 pixels and image acquisition speeds that can range up to 50 images per second, thereby allowing it to optimize the image acquisition.

As illustrated in FIGS. 3 to 5, the use of the device 1 for forming drops G1, G2 makes it possible to obtain several configurations of analysis of the interaction between drops G1, G2 of fluids F1, F2 which are immiscible in an ambient medium M.

As illustrated in FIG. 3, the device 1 for forming drops makes it possible to establish a first configuration PC1 in which a first drop G1 formed at the end 17 of the first capillary tube 16 and a second drop G2 formed at the end 27 of the second capillary tube 26 are distant from one another.

In this first configuration CF1, there are no interactions between the two drops G1, G2.

In this first configuration CF1, the image acquisition and processing device 30 is then suitable for collecting data relating to the dimensions and to the shape of the contour of the profile of the first drop G1 and data relating to the dimensions and to the form of the contour of the profile of the second drop G2.

These data may be collected and thus processed simultaneously.

As illustrated in FIG. 4, the device 1 for forming drops makes it possible to establish a second configuration CF2 in which the first drop G1 formed at the end 17 of the first capillary tube 16 and the second drop G2 formed at the end 27 of the second capillary tube 26 are in contact.

In this second configuration CF2, the image acquisition and processing device 30 is then suitable for collecting data relating to the dimensions and to the shape of the contour of the profile resulting from the contact of the first drop G1 and of the second drop G2.

As illustrated in FIGS. 5 and 6, the device 1 for forming drops makes it possible to establish a third configuration CF3 in which the first drop G1 formed at the end 17 of the first capillary tube 16 and the second drop G2 formed at the end 27 of the second capillary tube 26 disappear after coalescence.

In this third configuration CF3, the image acquisition and processing device 30 is then suitable for collecting data relating to the shape of the contour of the profile of a liquid bridge P resulting from the coalescence of the first drop G1 and of the second drop G2.

This bridge P may also be a gaseous bridge when the first fluid F1 and the second fluid F2 are a gas and the ambient medium M is liquid.

The processing means 40 comprise, for their part, a computer 41 suitable for performing a calculation algorithm.

The calculation algorithm is based on the data which are sent to it by the image acquisition and processing device 30 for determining the values of interfacial tension of the first drop G1 and/or of the second drop G2, in contact or not in contact, and of the interfacial tension of the liquid bridge P formed after coalescence of the two drops G1, G2.

Such a system 100 is suitable for implementing a process for analyzing the interaction between drops G1, G2 of fluids which are immiscible in an ambient medium M.

During this process, the operator begins first of all by actuating the movement means 13, 23 so as to form the first drop G1 and the second drop G2 respectively at the ends 17, 27 of the first capillary tube 16 and of the second capillary tube 26.

The device 1 for forming drops is then in the first configuration CF1 illustrated in FIG. 3.

In this first configuration CF1, the operator may perform an analysis of the first drop G1 and of the second drop G2 so as to determine the value of their respective interfacial tension.

The operator then actuates the movement means 5a, 5b so as to bring the device 1 into its second configuration CF2 illustrated in FIG. 4.

In this second configuration CF2, the operator may perform an analysis of the first drop G1 and of the second drop G2 so as to determine the value of their respective interfacial tension when the drops G1 and G2 are interacting with one another.

This analysis may be repeated several times over time so as to determine the stability over time of the value of the interfacial tension of the first drop G1 and of the second drop G2, especially if these values were very different before the contact.

This analysis may also be repeated several times while modifying each time the relative position of the two capillary tubes 16, 26, so as to apply, to the interface, a compression when the two ends 17, 27 are moved closer together, stretching when the two ends 17, 27 are moved further apart or else shearing when the two ends 17, 27 are rotated with respect to one another.

The operator then has the possibility of moving the ends 17, 27 of the two capillary tubes 16, 26 closer together so as to bring about the coalescence of the two drops G1, G2.

The coalescence of the two drops G1, G2 may also occur spontaneously over time without it having been necessary to move the ends 17, 27 of the two capillary tubes 16, 26 closer together.

The time taken for the coalescence of the two drops G1, G2, which depends on the pressure difference between the two fluids F1, F2, may moreover be measured and correlated with the values of the interfacial tensions of the two drops G1, G2 so as to provide information with regard to the stability of the interface.

This information is particularly advantageous for the production of an aqueous foam.

The device 1 for forming drops is then in the third configuration CF3 illustrated in FIGS. 5 and 6.

In this third configuration, the operator may perform an analysis of the liquid bridge P formed after the coalescence of the two drops G1, G2 so as to determine the value of its interfacial tension.

As in the second configuration CF2, the operator may also repeat this analysis several times while applying different stresses to the interface with the ambient medium M.

FIG. 6 shows a liquid bridge P to which a compression has been applied.

FIG. 9 shows, for its part, a drop G of fluid F placed in contact with a solid surface S in an ambient medium and the analysis of which can be carried out by means of an analyzing system 100′ provided as an alternative to the analyzing system 100 described above.

This analyzing system 100′ does not comprise a device 1 for forming two drops as in the system previously described, but a device 1′ for forming a single drop G.

This device 1′ for forming a drop G comprises a capillary tube 16 and a syringe-driver assembly 10 which are identical to the first capillary tube 16 and to the first syringe-driver assembly of the device 1 for forming two drops G1, G2.

In addition, the end 27 of the second capillary tube 26 and the second drop G2 are replaced with a solid surface S.

The system 100′ retains the movement means 13 which make it possible to bring the drop G into contact with the solid surface S, and also the image acquisition and processing device 30.

The image acquisition and processing device 30 is in this case suitable for collecting images relating to the dimensions and to the shape of the contour of an individual profile of the drop G before a contact between the drop G and the solid surface S, and to the shape of the contour of a contact profile of the drop G resulting from the contact between the drop G and the solid surface S.

Before contact, the system 100′ has an analysis configuration analogous to the first analysis configuration CF1 and, after the contact, the system 100′ has an analysis configuration analogous to the second analysis configuration CF2 described above with reference to the system 100 for analyzing the interaction between drops G1, G2 of fluids F1, F2 which are immiscible in an ambient medium M.

In order to be able to determine an interfacial tension value during these various analyses, the processing means 40 perform several operations.

These operations are in this case described with reference to a system 100 for analyzing the interaction between drops G1, G2 of fluids F1, F2 which are immiscible in an ambient medium M, but also apply, by analogy, to a system 100′ for analyzing the interaction between a drop G and a solid surface S.

The principle consists in modelling all the points of the contour of the drop along the curvilinear abscissa s and in performing successive approximations until an interfacial tension value is found for which the theoretical shape of the drop is as close as possible to the actual shape.

Thus, using the image transmitted by the image acquisition and processing device 30 onto the screen of the computer 41, the operator begins by manually defining a zone of optical analysis of a contour of the profile of the image of a drop G, G1, G2 or of an optical bridge P or else of the two drops G1, G2 simultaneously.

For this, the operator defines a first axis zₘᵢₙ and a second axis zₘₐₓ.

This first axis zₘᵢₙ and this second axis zₘₐₓ are horizontal on the image and transverse to the axis O_{z} of symmetry of the drop G, G1, G2 or of the liquid bridge P.

In the second analysis configuration CF2, and provided that the axis of symmetry O_{z} of the first drop G1 is perfectly aligned with the axis of symmetry O_{z} of the second drop G2, the operator may then define both a first zone of optical analysis for the first drop G1 and a second zone of analysis for the second drop G2.

The alignment of these two axes of symmetry is obtained by aligning the vertical rectilinear end portions 18, 28 of the first capillary tube 16 and of the second capillary tube 26, in particular using the movement means 13, 23.

An example of a zone of optical analysis is illustrated in FIG. 13.

Once this zone of optical analysis has been defined, the algorithm will extract, from the image, the position of experimental points of the contour of the profile located in the zone of optical analysis.

This extraction is obtained by local thresholding on the basis of a histogram of the levels of grey and sub-pixellization using a method termed Spline approximation method.

This thresholding consists in using the gradient of the levels of grey in the four fundamental directions (0°, 45°, 90° and 135°) to determine the contour of the profile with a precision of about 0.1 to 0.2 pixel.

The electronic noise on a fixed object is about 0.1 pixel and it is substantially Gaussian.

On the basis of the experimental points, the processing means 40 empirically pinpoint the position of a point M₀ of coordinates M₀ {s=0, x=R₀, z=0}.

The point M₀ is thus located at the intersection of the experimental profile contour and of the horizontal axis Oₓ.

The position of this point M₀ allows the processing means 40 to determine a first estimation of:
the polar angle θ₀ of the oriented tangent at M₀, point located on the reference plane defining a horizontal axis Oₓ,
R₀, the radius of curvature in a plane orthogonal to the axis of revolution and passing through the axis Oₓ,
the mean curvature b at the point M₀,
the capillary constant c at the interface between the fluid F1, F2 under consideration and the ambient medium M.

This first estimation of the four parameters (b, c, R₀, q₀) defines initialization conditions allowing the algorithm performed by the computer 41 to obtain a first theoretical profile contour.

For this, starting from equation (3), if the following is written:

$$\frac{d}{dx} ( x sin θ ) = 2 bx - cxz$$

$${M}_{0} \{ s = 0 , x = {R}_{0} , z = 0 \}$$

and integration for x between 0 and x is performed, this gives, after a change of variable and an integration by parts:

2∫_{z}_{₀}^{z}zxdz=x²z−x₀²z₀−∫_{z}_{₀}^{z}x²dz

Where the calculation of the volume is recognized since:

Vol(z)=∫_{z}_{₀}^{z}πx²dz

The following formula is deduced therefrom:

$$x sin θ = {bx}^{2} + \frac{c}{2} ( V ( z ) - {x}^{2} z )$$

This formula can be written out for any series of measurements, such that:

∀i,A(V(zᵢ)−xᵢ²zᵢ)+Bxᵢ²=xᵢ sin θᵢ (5)

The algorithm then determines, for each value of zᵢ on the profile contour, the values of xᵢ of θᵢ and, by numerical integration, the value of V(zᵢ), for example by the trapezium method.

To estimate the values of θ along the contour, the algorithm then reads the profile using a splines approximation method.

The algorithm thus performs a linear regression so as to calculate the variables A and B of equation (5) and then work back to the coefficients b and c.

The initial estimation of R₀ and q₀ is carried out using the same geometrical argument given that R₀=x₀ while considering that the first point is that located on the first line of analysis, that is to say x₀=R₀, z₀=0.

The processing means 40 then determine a difference between the experimental points and the points of this first theoretical profile.

As illustrated in FIG. 12, any experimental point Eᵢ is projected orthogonally onto the LaPlace curve associated with the objective function L(b, c, R₀, θ₀) at a point Pi pinpointed on the theoretical curve by its curvilinear abscissa sᵢ which is calculated by minimization of the square function of the distance Φ(s):

Φ(s)=(x(s)−Xᵢ)²+(z(s)−Zᵢ)²

The distance between the theoretical LaPlace curve associated with the objective function L(b, c, R₀, θ₀) and the experimental points is taken in the quadratic sense and gives the objective function:

$$L ( b , c , {R}_{0} , {θ}_{0} ) = \frac{1}{2} {\sum }_{i} {( x ( s ) - {X}_{i} )}^{2} + {( z ( s ) - {Z}_{i} )}^{2}$$

This objective function represents a quadratic error function between the first theoretical profile and the experimental points.

The processing means 40 will thus seek to minimize this quadratic error function in order to determine the best values of the four parameters (b, c, R₀, q₀) and thus the best LaPlace curve associated with the objective function L(b, c, R₀, θ₀) of approximation of the experimental points and solution of the differential equation (4):

$$[ E ] \text{:} \{ \begin{matrix}\frac{dx}{ds} = cos θ \\ \frac{dz}{ds} = sin θ \\ \frac{d θ}{ds} = 2 b - \frac{sin θ}{x} - cz\end{matrix}$$

with, as initial conditions at the point M₀:

$$[ {EC}_{0} ] \text{:} \{ \begin{matrix}x ( 0 ) = {R}_{0} \\ z ( 0 ) = 0 \\ θ ( 0 ) = {θ}_{0}\end{matrix}$$

To calculate this minimized error function, the algorithm relies on an automatic program derivation based both on the method for solving a differential equation with Bragg-Stoer-Bulirsch initial conditions and a non-linear optimization by the Newton-Raphson method and makes it possible to obtain a second optimized estimation of the four parameters (b, c, R₀, θ₀) by an approximation of the contour of the profile of the first drop G1 and/or of the second drop G2, and/or where appropriate of the contour of the profile of the liquid bridge P with a LaPlace curve associated with the objective function L(b, c, R₀, θ₀), namely the solution of the LaPlace equation defined by differential equation (4) taking, as initial conditions:

$$[ {EC}_{0} ] \text{:} \{ \begin{matrix}x ( 0 ) = {R}_{0} \\ z ( 0 ) = 0 \\ θ ( 0 ) = {θ}_{0}\end{matrix}$$

If the values of the four parameters (b, c, R₀, θ₀) are such that the difference between the experimental profile and a better theoretical profile of a contour of the profile of the drop G, G1, G2 is below a predetermined applicability threshold, then the processing means 40 then determine a value of interfacial tension of the drop G, G1, G2, or of the liquid bridge P and also a value of pressure difference between the internal pressure of the drop G, G1, G2 and the pressure in the ambient medium M.

In the case where the values of the four parameters (b, c, R₀, θ₀) are such that this difference is above the predetermined applicability threshold, then a value of pressure difference between the internal pressure of the drop G, G1, G2, where appropriate of the liquid bridge P, and the pressure in the ambient medium M is taken using pressure sensors 7a, 7b suitable for measuring the pressure in the first capillary tube 16 and, where appropriate, in the second capillary tube 26.

As illustrated in FIG. 10, these pressure sensors 7a, 7b are connected to a connecting tee 8 inserted between the capillary tubes 16, 26 and the syringe-driver assemblies 10, 20.

The processing means 40 return, in addition to the values of the parameters b, c, R₀, θ₀ and a LaPlace curve associated with the optimized objective function L(b, c, R₀, θ₀), the list of standard errors between the experimental points and the best profile contour, and also the volume, the surface area and the contact angles of the drop or of the liquid bridge at the various points of the curvilinear abscissa s.

In addition, the algorithm is also capable of determining these values by extrapolation on points located between two planes of height z₁ and z₂ which go beyond the two planes zₘᵢₙ, zₘₐₓ delimiting the zone of optical analysis.

The present invention may have various industrial applications or research applications, in particular in the oil sector and in life sciences.

In the oil sector, the interactions between drops are important to characterize in enhanced oil recovery processes in which drops are moved with respect to one another in the porous media.

This involves, for example, characterizing the water/oil encounter so as to consolidate the interface.

The process according to the invention makes it possible to study the interaction between two drops G1, G2 of different nature and analyzes the behaviour of the interface.

The process also makes it possible to achieve stability of the interfaces between media of the same nature, for example petroleum-based oils, and films thus formed so as to be able to work back to the stability of petroleum emulsions.

The strength of the process lies in its ability to be able to quantitatively measure the interaction of two fluids and to be able to model actual phenomena.

It is now possible to collect new data in terms of tension and rheology of interfacial films under stresses, for example shear stresses.

In the life sciences, the second configuration CF2 of the device 1 for forming drops makes it possible to form a contact interface between the first drop G1 and the second drop G2.

This interface may, under certain conditions, resemble the composition of a portion of cell membrane of a living cell.

A cell membrane comprises essentially a phospholipid bilayer.

The phospholipids are amphiphilic structures which have a hydrophilic head and two adjacent hydrophobic tails.

Phospholipids have a behaviour similar to that of surfactants which migrate at the interface.

In a cell membrane, phospholipids form a bilayer in which the hydrophobic tails of the phospholipids of a first layer are arranged facing the hydrophobic tails of the phospholipids of a second layer, while the hydrophilic heads of the phospholipids of the first layer are arranged in opposition to the hydrophilic heads of the phospholipids of the second layer.

Consequently, if a first drop G1 of fluid containing surfactants is brought into contact with a second drop G2 containing surfactants, then a part of the surfactants initially present at the interface of the two drops G1, G2 with the ambient medium M will organize at the interface between the first drop G1 and the second G2 so as to form a surfactant bilayer with the same arrangement as that which can be found in a cell membrane.

At equilibrium, a model of a portion of cell membrane is thus obtained.

This cell membrane portion model can be used to reproduce the behaviour of certain molecules on contact with a cell membrane, for example the active ingredient of a drug.

Using a device 1 for forming drops as illustrated in FIG. 5, it is thus possible to inject into the first drop G1 a volume of fluid F1 comprising a molecule C by means of the hollow needle while at the same time preserving a constant volume of drop G1 by simultaneously suctioning an equivalent volume of fluid F1 by means of the first capillary tube 16.

Of course, according to one variant, the molecule could also be injected into the second drop G2.

The molecule may then migrate toward the interface between the first drop G1 and the second drop G2.

It is then possible to determine the influence of this molecule on the interfacial tension of the first drop G1 and to determine the capacity of this molecule to cross the interface between the first drop G1 and the second drop G2.

This capacity for diffusion across the interface between the first drop G1 and the second drop G2 may be determined from the variation in the interfacial tension of the second drop G2 or else from the detection of a marker of the molecule, for example a fluorescent marker.

During the injection of the molecule in the fluid F1 of the first drop G1, the molecule may also not migrate toward the interface, thereby also providing important information regarding the efficacy of the molecule.

The objective may also consist in developing a molecule which does not modify the interfacial tension of the first drop G1 and of the second drop G2 when it diffuses through the interface.

Thus, this process may be carried out in order to quantify the stability of the interfaces in contact between a molecule and:
a carrier,
its environment with any type of physiological medium, for example plasma, synovial fluid, pulmonary surfactant, lymph, cerebrospinal fluid, saliva,
any cell type,
any type of cell membrane,
any type of epithelium,
any type of cell organelle.

The analyzing process according to the invention may also be carried out in order to quantify the stability of the interfaces in contact between a carrier and:
its environment in a physiological medium,
a cell,
a cell membrane,
organelles.

Although the invention has been described in relation to specific implementation examples or specific embodiments of the process, other variants and improvements of the invention may be envisaged without, however, departing from the context of the invention.

1. A device for forming and bringing into contact drops of fluids which are immiscible in an ambient medium, comprising:
a first capillary tube comprising an end capable of opening out into the ambient medium and a rectilinear end portion extending vertically from the end of the first capillary tube,
a first syringe-driver assembly connected to the first capillary tube and suitable for:
conveying a first fluid through the first capillary tube to the end of the first capillary tube, and
controlling a volume of a first drop of first fluid formed at the end of the first capillary tube,
a second capillary tube comprising an end capable of opening out into the ambient medium and a rectilinear end portion extending vertically from the end of the second capillary tube,
a second syringe-driver assembly connected to the second capillary tube and suitable for:
conveying a second fluid through the second capillary tube to the end of the second capillary tube, and
controlling a volume of a second drop of a second fluid formed at the end of the second capillary tube in the ambient medium,
means for bringing the first and second drops into contact, having a relative arrangement of the end of the first capillary tube with respect to the end of the second capillary tube that is suitable for bringing the first and second drops into contact,
wherein the first capillary tube comprises a hollow needle placed coaxially inside the first capillary tube and protruding at the end of the first capillary tube, and/or the second capillary tube comprises a hollow needle placed coaxially inside the second capillary tube and protruding at the end of the second capillary tube.

2. A device for forming a drop of fluid which is immiscible in an ambient medium and bringing the drop of fluid which is immiscible in an ambient medium into contact with a solid surface, comprising:
a capillary tube comprising an end capable of opening out into the ambient medium and a rectilinear end portion extending vertically from the end of the capillary tube,
a syringe-driver assembly connected to the capillary tube and suitable for:
conveying a fluid through the capillary tube to the end of the capillary tube, and
controlling a volume of a drop of fluid formed at the end of the capillary tube,
means for bringing the drop into contact, having a relative arrangement of the end of the capillary tube with respect to the solid surface that is suitable for bringing the drop and the solid surface into contact,
wherein the capillary tube comprises a hollow needle placed coaxially inside the capillary tube and protruding at the end of the capillary tube.

3. The device according to claim 1, wherein the means for bringing into contact comprise means for relative movement of the end of the first capillary tube with respect to the end of the second capillary tube.

4. The device according claim 1, wherein the rectilinear end portion of the first capillary tube and the rectilinear end portion of the second capillary tube are placed along one and the same axis, the end of the first capillary tube and the end of the second capillary tube being placed opposite one another in the ambient medium.

5. The device according to claim 1, wherein the rectilinear end portion of the first capillary tube and the rectilinear end portion of the second capillary tube are respectively placed along first and second substantially parallel axes, the end of the first capillary tube and the end of the second capillary tube being placed side by side in the ambient medium.

6. The device according to claim 1, wherein the means for relative movement comprise means for translational movement or means for translational and rotational movement.

7. The device according to claim 1, wherein the end of the first capillary tube and/or the end of the second capillary tube are placed in a transparent cuvette.

8. The device according to claim 1, wherein the end of the first capillary tube and/or the end of the second capillary tube are placed in a thermostatic chamber.

9. A system for analyzing the interaction between drops of fluids which are immiscible in an ambient medium, comprising:
a device for forming drops and bringing drops into contact comprising:
a first capillary tube comprising an end capable of opening out into the ambient medium and a rectilinear end portion extending vertically from the end of the first capillary tube,
a first syringe-driver assembly connected to the first capillary tube and suitable for:
conveying a first fluid through the first capillary tube to the end of the first capillary tube, and
controlling a first volume of a first drop of first fluid formed at the end of the first capillary tube,
a second capillary tube comprising an end capable of opening out into the ambient medium and a rectilinear end portion extending vertically from the end of the second capillary tube,
a second syringe-driver assembly connected to the second capillary tube and suitable for:
conveying a second fluid through the second capillary tube to the end of the second capillary tube, and
controlling a second volume of a second drop of a second fluid formed at the end of the second capillary tube in the ambient medium,
means for bringing the first and second drops into contact, having a relative arrangement of the end of the first capillary tube with respect to the end of the second capillary tube that is suitable for bringing the first and second drops into contact;
an image acquisition and processing device suitable for collecting data relating to dimensions and shape of a contour:
of an individual profile of the first drop and of an individual profile of the second drop before contact between the first drop and the second drop, or
of a profile of contact of the first drop and of the second drop resulting from contact between the first drop and the second drop, or
of a profile of a liquid bridge resulting from a coalescence between the first drop and the second drop, and
processing means suitable for determining according to data collected by the image acquisition and processing device:
a value of interfacial tension:
of the first drop and of the second drop before the contact between the first drop and the second drop,
of the first drop and of the second drop after the contact between the first drop and the second drop,
of the liquid bridge resulting from the coalescence between the first drop and the second drop, and/or
a pressure difference value:
between an internal pressure of the first drop and a pressure of the ambient medium and between an internal pressure of the second drop and the pressure of the ambient medium, and/or
between an internal pressure of the liquid bridge and the pressure of the ambient medium.

10. A system for analyzing the interaction of a drop of immiscible fluid with a solid surface in an ambient medium, comprising:
a device for forming a drop and bringing the drop into contact with the solid surface, comprising:
a capillary tube comprising an end capable of opening out into the ambient medium and a rectilinear end portion extending vertically from the end of the capillary tube,
a syringe-driver assembly connected to the capillary tube and suitable for:
conveying a fluid through the capillary tube to the end of the capillary tube, and
controlling a volume of a drop of fluid formed at the end of the capillary tube,
means for bringing the drop into contact, having a relative arrangement of the end of the capillary tube with respect to the solid surface that is suitable for bringing the drop and the solid surface into contact;
an image acquisition and processing device suitable for collecting images relating to dimensions and to the shape of a contour:
of an individual profile of the drop before the contact between the drop and the solid surface,
of a contact profile of the drop resulting from the contact between the drop and the solid surface,
processing means suitable for determining, according to data collected by the image acquisition and processing device:
a value of interfacial tension:
of the drop before the contact between the drop and the solid surface,
of the drop after the contact between the drop and the solid surface, and/or
a value of pressure difference between an internal pressure of the drop and a pressure of the ambient medium.

11. The system according claim 9, comprising a first pressure sensor suitable for measuring the pressure in the first capillary tube and, where appropriate, a second pressure sensor suitable for measuring the pressure in the second capillary tube.

12. The system according to claim 9, wherein the image acquisition and processing device comprises:
a light source mounted on a first side of an optical bench, and
a camera mounted on a second side of said optical bench,
the device for forming drop(s) being placed in alignment with the optical bench between the light source and the camera.

13. A process for analyzing the interaction between drops of fluids which are immiscible in an ambient medium, comprising the following steps:
providing the analyzing system according to claim 9,
forming the first drop of the first fluid at the end of the first capillary tube placed in the ambient medium,
forming the second drop of the second fluid at the end of the second capillary tube placed in the ambient medium,
moving the end of the first capillary tube with respect to the end of the second capillary tube until there is contact between the first drop and the second drop,
determining a minimized quadratic error function using the processing means so as to obtain a better value of four parameters (b, c, R₀, q₀) of a LaPlace curve associated with an objective function L(b, c, R₀, q₀), said minimized quadratic error function characterizing a difference between an experimental profile and a better theoretical profile of the contour of the profile of the drop,
if the values of the four parameters are such that this difference is below a predetermined applicability threshold, then determining, using the processing means:
a value of interfacial tension of the first drop and of the second drop after the contact between the first drop and the second drop, and/or a value of interfacial tension of the liquid bridge resulting from the coalescence between the first drop and the second drop, and
the values of the internal pressures in the first drop and the second drop and/or the value of the internal pressure in the liquid bridge,
if the values of the four parameters are such that this difference is not below a predetermined applicability threshold, then,
determining a value of pressure difference between the internal pressure of the first drop and the pressure of the ambient medium, and between the internal pressure of the second drop and the pressure of the ambient medium, by means of pressure sensors suitable for measuring a pressure in the first capillary tube and in the second capillary tube.

14. A process for analyzing the interaction between drops of fluids which are immiscible in an ambient medium, comprising the following steps:
providing the analyzing system according to claim 9,
forming the first drop of the first fluid at the end of the first capillary tube placed in the ambient medium,
forming the second drop of the second fluid at the end of the second capillary tube placed in the ambient medium,
moving the end of the first capillary tube with respect to the end of the second capillary tube until there is contact between the first drop and the second drop,
determining a minimized quadratic error function using the processing means so as to obtain a better value of four parameters (b, c, R₀, q₀) of a LaPlace curve associated with an objective function L(b, c, R₀, q₀), said minimized quadratic error function characterizing a difference between an experimental profile and a better theoretical profile of the contour of the profile of the drop,
if the values of the four parameters are such that this difference is below a predetermined applicability threshold, then determining, using the processing means:
a value of interfacial tension of the first drop and of the second drop after the contact between the first drop and the second drop, and/or a value of interfacial tension of the liquid bridge resulting from the coalescence between the first drop and the second drop, and
the values of the internal pressures in the first drop and the second drop and/or the value of the internal pressure in the liquid bridge,
if the values of the four parameters are such that this difference is not below a predetermined applicability threshold, then,
determining a value of pressure difference between the internal pressure of the first drop and the pressure of the ambient medium, and between the internal pressure of the second drop and the pressure of the ambient medium, by means of pressure sensors suitable for measuring a pressure in the first capillary tube and in the second capillary tube.

15. The process according to claim 13, wherein the first drop has a first interfacial tension value and the second drop has a second interfacial tension value different from the first interfacial tension value before contact between the first drop and the second drop, said process also comprising repeating at least one step comprising determining a value of interfacial tension of the first drop and of the second drop after the contact between the first drop and the second drop.

16. The process according to claim 13, further comprising timing, after the contact between the first drop and the second drop, a time taken to obtain coalescence between the first drop and the second drop.

17. The process according to claim 13, comprising steps consisting in:
increasing or decreasing a volume of the liquid bridge,
stretching an interface of the liquid bridge with the ambient medium by modifying the distance between the end of the first capillary tube and the end of the second capillary tube, or
shearing the interface of the liquid bridge by rotating the end of the first capillary tube with respect to the end of the second capillary tube.

18. The process according to claim 13, wherein determining the minimized quadratic error function, the interfacial tension value, and the internal pressure value of the drop using the processing means comprises the following operations:
defining at least one zone of optical analysis of the contour of the profile from an image of the profile of contact of the first drop and of the second drop resulting from the contact between the first drop and the second drop and/or from an image of the profile of the liquid bridge resulting from the coalescence between the first drop and the second drop,
extracting from the image a position of experimental points of at least one of the group consisting of the contour of the profile of the first drop, the contour of the profile of the second drop, and the contour of the profile of the liquid bridge, and
on the basis of the experimental points, carrying out a first estimation of:
a polar angle θ₀ of an oriented tangent at point M₀ located on a reference plane defining a horizontal axis Oₓ,
R₀, a radius of curvature in a plane orthogonal to an axis of revolution and passing through the axis Oₓ,
a mean curvature b at the point M₀,
a capillary constant c at the interface between the fluid under consideration and the ambient medium,
applying an algorithm so as to deduce, from the first estimation of the four parameters (b, c, R₀, q₀) and the acquisition of experimental points of the contour of the profile, a second optimized estimation of the four parameters (b, c, R₀, q₀) by an optimized approximation of the contour of the profile of the first drop, the contour of the profile of the second drop, the contour of the profile of the liquid bridge, and/or the contour of the profile of the drop via a LaPlace curve associated with the objective function L(b, c, R₀, θ₀) which solves the differential equation E:
$$[ E ] \text{:} \{ \begin{matrix}\frac{dx}{ds} = cos θ \\ \frac{dz}{ds} = sin θ \\ \frac{d θ}{ds} = 2 b - \frac{sin θ}{x} - cz\end{matrix}$$
with, as initial conditions at the point M₀:
$$[ {EC}_{0} ] \text{:} \{ \begin{matrix}x ( 0 ) = {R}_{0} \\ z ( 0 ) = 0 \\ θ ( 0 ) = {θ}_{0}\end{matrix}$$
determining the minimized quadratic error function and determining the interfacial tension value and the internal pressure value of the first drop, the second drop, the liquid bridge, and/or of the drop as a function of the optimized approximation obtained in the preceding step.

19. The process according to claim 18, wherein the minimized quadratic error function is determined by automatic program derivation for using a minimization method together with a method for numerical solution of the differential equation [E].

20. The process according to claim 18, wherein the at least one zone of optical analysis of the contour of the profile is selected between a first horizontal axis located in proximity to the interface between the first and second drops and a second horizontal axis located in proximity to the end of the first capillary tube for a measurement on the first drop or in proximity to the end of the second capillary tube for a measurement on the second drop.

21. The process according to claim 18, in which the extraction, on the image, of the position of experimental points of the contour of the profile comprises thresholding obtained from a histogram of levels of grey and sub-pixellization by means of a method termed Spline approximation method.

22. (canceled)

23. (canceled)

24. The device of claim 2, where the means for bringing into contact comprise means for relative movement of the end of the capillary tube with respect to the solid surface.

25. The process of claim 14, wherein determining the minimized quadratic error function, the interfacial tension value, and the internal pressure value of the drop using the processing means comprises the following operations:
defining at least one zone of optical analysis of the contour of the profile from an image of a profile of a drop resulting from a contact between the drop and a solid surface,
extracting from the image a position of experimental points of the drop, and on the basis of the experimental points, carrying out a first estimation of:
a polar angle θ₀ of an oriented tangent at point M₀ located on a reference plane defining a horizontal axis Oₓ,
R₀, a radius of curvature in a plane orthogonal to an axis of revolution and passing through the axis Oₓ,
a mean curvature b at the point M₀,
a capillary constant cat the interface between the fluid under consideration and the ambient medium,
applying an algorithm so as to deduce, from the first estimation of the four parameters (b, c, R₀, q₀) and the acquisition of experimental points of the contour of the profile, a second optimized estimation of the four parameters (b, c, R₀, q₀) by an optimized approximation of the contour of the profile of the drop via a LaPlace curve associated with the objective function L(b, c, R₀, θ₀) which solves the differential equation E:
$$[ E ] \text{:} \{ \begin{matrix}\frac{dx}{ds} = cos θ \\ \frac{dz}{ds} = sin θ \\ \frac{d θ}{ds} = 2 b - \frac{sin θ}{x} - cz\end{matrix}$$
with, as initial conditions at the point M₀:
$$[ {EC}_{0} ] \text{:} \{ \begin{matrix}x ( 0 ) = {R}_{0} \\ z ( 0 ) = 0 \\ θ ( 0 ) = {θ}_{0}\end{matrix}$$
determining the minimized quadratic error function and determining the interfacial tension value and the internal pressure value of the drop as a function of the optimized approximation obtained in the preceding step.

26. The process of claim 25, wherein the at least one zone of optical analysis of the contour of the profile is selected between a first horizontal axis located in proximity to the solid surface and a second horizontal axis located in proximity to the end of the capillary tube.

27. The process of claim 18, wherein the at least one zone of optical analysis of the contour of the profile is selected between a first horizontal axis located in proximity to the end of the second capillary tube and a second horizontal axis located in proximity to the end of the first capillary tube.

28. The system of claim 9, wherein a cell membrane is analyzed.

29. The process of claim 13, wherein a cell membrane is analyzed.

30. The system of claim 10, wherein the drop of fluid is a hydrocarbon.

31. The process of claim 14, wherein the drop of fluid is a hydrocarbon.
